(19) United States
(12) Patent Application Publication
(10) Pub. No.: US 2013/0291003 A1
(43) Pub. Date: Oct. 31, 2013

(54) METHOD FOR MANAGING CONTENTS AND IMAGE DISPLAY DEVICE THEREFOR

(71) Applicant: Inchul Lee, Seoul (KR)

(72) Inventor: Inchul Lee, Seoul (KR)

(21) Appl. No.: 13/978,430

(22) PCT Filed: Oct. 11, 2011
(86) PCT No.: PCT/KR11/07531

§ 371 Date: Jul. 5, 2013

(51) Int. Cl. H04N 21/81

(52) U.S. Cl. CPC H04N 21/8173
USPC 725/25

(57) ABSTRACT

Disclosed are an image display device and content management method using the same. The content management method includes obtaining at least one trial application from an application list stored in an image display device, searching the application list for at least one trial application, extracting state information of the stored trial application, determining state display information for displaying the trial application on the image display device on the basis of the state information, and displaying a list of applications in which the at least one trial application is included. Accordingly, a user is induced to select, execute, or delete an application according to a state of the trial application.

### TECHNICAL FIELD

The present disclosure relates to an image display device and content management method using the same, and more particularly, to a method of displaying an application of a trial version on the basis of state information such as validity period to allow a user to easily know.

### BACKGROUND ART

An image display device is, for example, a device having a function for receiving and processing broadcast images that a user can watch. An image display device displays, on a display, for example, a broadcast selected by a user from among broadcast signals transmitted from broadcasting companies. Currently broadcast tends to be world-widely converted into a digital broadcast from an analog broadcast.

A digital broadcast indicates a broadcast through which digital images and audio signals are transmitted. Since a digital broadcast is more robust to an external noise than an analog broadcast, it is more advantageous to error correction, has a less data loss, a higher resolution, and a higher sharpness. Also, a digital broadcast can provide an interactive service unlike an analog broadcast.

Performance improvement and functional diversity for an image display device has been achieved in order to be used in a digital broadcast including various contents. Through the improved performance of the image display device, not only simply receiving image signals from a broadcasting company and watching a broadcast, but various functions such as game playing, listening to music, and internet shopping can be also performed by using various applications.

Nowadays, due to popularization of a smart phone and a digital TV, applications such as a game are downloaded, and trial version applications are generated and provide users with chances to download and experience them on an image display device. However, it is difficult to efficiently use the trial applications due to a limited memory in the image display device and restricted use conditions of the trial applications. In detail, a user, who knows of the trial application and once uses it, considers he or she cannot use it any longer and neglects a chance of using it later. In addition, it frequently occurs that time expired applications remain in an image display device and occupy a memory.

### DISCLOSURE OF THE INVENTION

### Technical Problem

Embodiments provide a content management method capable of extracting state information on availability of trial applications to display it for a user to easily know.

### Technical Solution

In one embodiment, a content management method includes: obtaining at least one trial application from an application list stored in an image display device; extracting state information of the stored trial application; and adjusting at least one of transparency and supplementary display information for an image representing the at least one trial application on the basis of the extracted state information to display the at least one trial application.

In another embodiment, an image display device managing content, includes: a controller obtaining at least one trial application from an application list stored in the image display device, and extracting state information of the stored trial application; and a display unit adjusting at least one of transparency and supplementary display information for an image representing the at least one trial application on the basis of the extracted state information to display the at least one trial application.

### Advantageous Effects

According to the embodiments, a user's attention can be attracted by easily understandably and instantly displaying use states of trial applications.

According to the embodiments, a memory in an image display device can be efficiently used by allowing a user to arrange or delete trial applications.

### BRIEF DESCRIPTION OF THE DRAWINGS

FIG. 1 is a view schematically illustrating an embodiment of a configuration of a broadcast system.

FIG. 2 is a view illustrating another embodiment of a configuration of the broadcast system.

FIG. 3 is a view illustrating a method of transmitting and receiving data between an image display device and a service provider.

FIG. 4 is a block diagram illustrating a configuration of an image display device according to an embodiment.

FIG. 5 is a block diagram illustrating a configuration of the image display device according another embodiment.

FIG. 6 is a simplified block diagram illustrating a data flow displaying state information of an application according to an embodiment.

FIG. 7 illustrates an example in which an application list is displayed on an image display device according to an embodiment.

FIG. 8 illustrates an example in which application states are displayed according to an embodiment.

FIG. 9 illustrates supplementary display information on state information of applications according to an embodiment.

FIG. 10 is an exemplified arrangement of applications according to an embodiment.

FIG. 11 is a flow chart of a content management method according to an embodiment.

### MODE FOR CARRYING OUT THE INVENTION

Hereinafter, the present disclosure will be described in detail with reference to the accompanying drawings.

In the following description, usage of suffixes such as ‘module’ and ‘unit’ used for referring to elements is given merely to facilitate explanation of the present disclosure, without having any significant meaning by itself. It should be noted that ‘module’ and ‘unit’ can be mixedly used.

Furthermore, an image display device described herein is, for example, an intelligent image display device that a computer supporting function is added to a broadcast reception function. Therefore, the image display device has an Internet function and is equipped with an interface such as a manual type input device, a touch screen, or a spatial remote control, for convenient use, as well as is faithful to the broadcast reception function. In addition, functions such as an email, web browsing, banking, or a game may be performed by connecting to the internet and a computer with a wired or wireless internet function supported. For these various functions, a standardized general-purpose OS may be used.

Accordingly, since, in the image display device described in the present disclosure, for example, various applications are freely added or deleted to or from the general-purpose OS kernel, various user-friendly functions may be performed. In detail, the image display device may be a network TV, a hybrid broadcast broadband (HBB) TV, or a smart TV. In some cases, a smart phone may be also employed.

Hereinafter, embodiments will be described in detail with reference to the attached drawings and content included in the attached drawings, but the present disclosure is not limited to the embodiments.

The terms used in this specification are selected to include current, widely-used, general terms, in consideration of the functions of the present disclosure. However, the terms may represent different meanings according to the intentions and the practices of the skilled person in the art, the appearance of new technology, etc. In certain cases, a term may be one that is arbitrarily established by the applicant. In such cases, the meaning of the term will be defined in the relevant portion of the detailed description. As such, the terms used in the specification are not to be defined simply by the name of the terms but are to be defined based on the meanings of the terms as well as the overall description of the present disclosure.

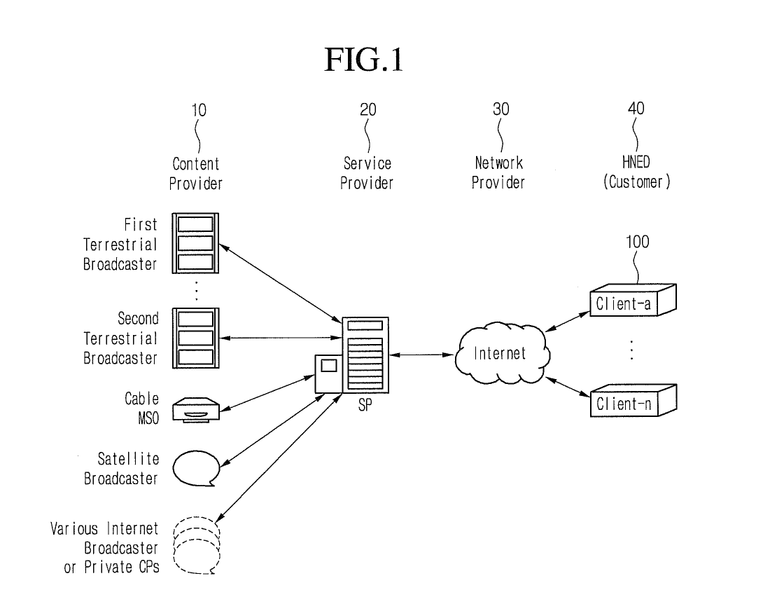

FIG. 1 illustrated an embodiment of a configuration of a broadcast system, which is a view schematically illustrating an exemplified entire broadcast system including an image display device according to an embodiment.

Referring to FIG. 1, the broadcast system is divided into a content provider (CP) 10, a service provider (SP) 20, a network provider (NP) 30 and a home network end user (HNED) 40.

The HNED 40 may correspond to a client 100, which is an image display device according to an embodiment. For example, the client 100 may be a network TV, a smart TV, or an IPTV.

Furthermore, the content provider 10 makes and provides various contents, and, as shown in FIG. 1, a terrestrial broadcaster, a cable system operator (SO), a multiple system operator (MSO), a satellite broadcaster, and an Internet broadcaster, etc.

Also, the content provider 10 may provide various applications besides broadcast contents. This will be described in detail later.

The service provider 20 may make contents provided by the content provider 10 into service-packages and provide them. For example, the service provider 20 may make a first terrestrial broadcast, a second terrestrial broadcast, a cable MSO, a satellite broadcast, various internet broadcast, and applications into packages to provide them to a user.

In addition, the service provider 20 may provide a service towards a client 100 by using a unicast or multicast scheme.

In the unicast scheme, data is transmitted between a single transmitter and a signal receiver in a one-to-one correspondence. For example, when a receiver requests data from a server, the server may transmit the data to the receiver according to the request.

In the multicast scheme, data is transmitted to a plurality of receivers in a specific group. For example, a server may transmit data to a plurality of pre-registered receivers all together. For this multicast registration, an internet group management protocol (IGMP) may be used.

The network provider 30 may provide the client 100 with a network for providing the above-described service, and the client 100 may construct an HNED to receive the service.

As a means for protecting content transmitted from the above-described system, a conditional access or content protection may by used. As an example of the conditional access or the content protection, a scheme such as CableCard or a downloadable conditional access (DCAS) may by used.

Furthermore, the client 100 is able to provide content through a network. In this case, the client 100 may be a content provider, and the content provider 10 may receive content from the client 1000. Accordingly, an interactive content service or a data service may be possible.

According to an embodiment, the content provider 10 may provide various contents including movies, music, images, games, and applications. Also, contents provided by the content provider 10 also include trial applications whose periods of use or authorities of use are limited.

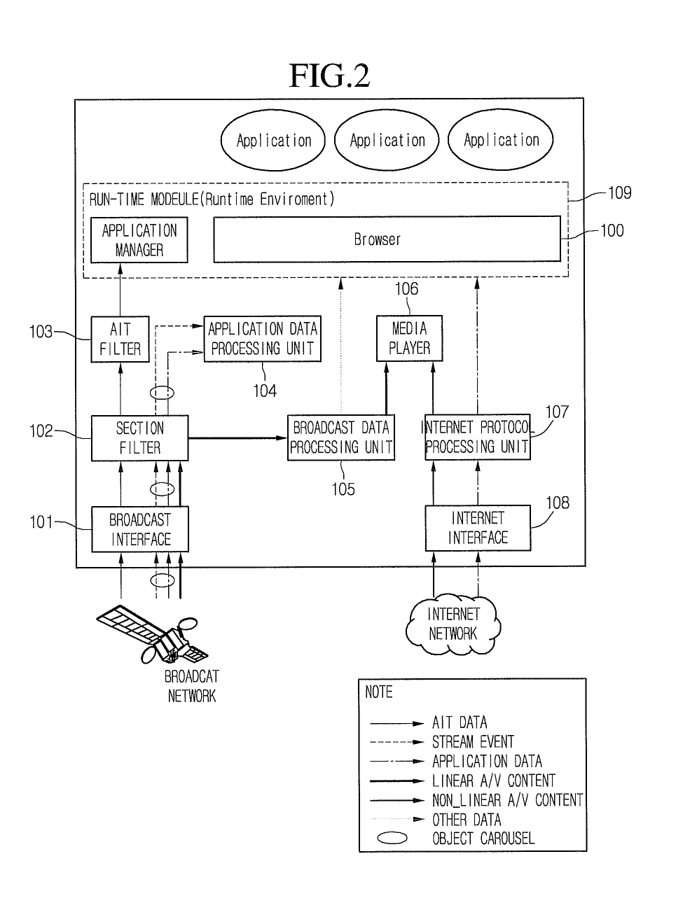

Referring FIG. 2, the image display device 10, corresponding to the client as shown in FIG. 1, may be connected to a broadcast network and the internet.

For example, the image display device 100 may include a broadcast interface 101, a section filter 102, an application information table (AIT) filter 103, an application data processing unit 104, a broadcast data processing unit 105, a media player 106, an internet protocol processing unit 107, an internet interface 108, and a run-time module 109.

Furthermore, the broadcast interface 101 of the image display device 100 may receive AIT data, real-time broadcast content, application data or a stream event, etc., and the real-time broadcast content may be linear A/V content.

The section filter 102 performs section-filtering on 4 kinds of data received through the broadcast interface 101 and may transmit the AIT data, the linear A/V content, and the stream event and the application data respectively to the AIT filter 103, the broadcast data processing unit 105, and the application data processing unit 104.

The internet interface 108 may receive non-linear A/V content and application data, and the non-linear A/V content may be a content on demand (COD) application.

The non-linear A/V content may be transmitted to the media player 106 and the application data may be transmitted to the run-time module 109.

In addition, the run-time module 109 may include an application manager and a browser, the application manager may control lifecycle for an interactive application by using the AIT data, and the browser may perform a function of displaying and processing the interactive application.

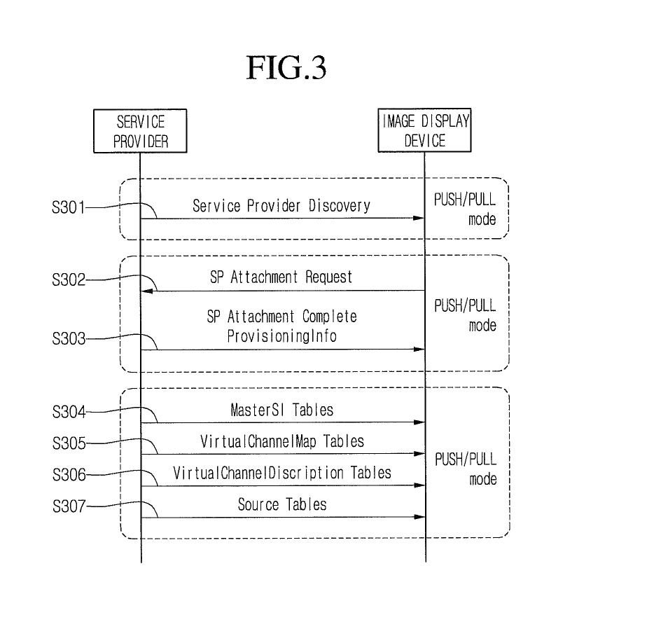

FIG. 3 illustrates an embodiment of a method of transmitting and receiving data between the image display device and the service provider.

Referring to FIG. 3, the service provider performs a service provider (SP) discovery operation in operation 5301. The image display device transmits an SP attachment request signal in operation S302. When the SP attachment is completed, the image display device receives provisioning information in operation S303. In addition, the image display device receives a master service information (SI) table in operation S304, receives a virtual channel map table in operation 5305, receives a virtual channel description table in operation 5306, and receives a source table in operation 5307.

For example, the SP discovery operation may indicate a process that service providers providing IPTV-related services search a server which provides information on their services. There may be the following three ways to search an address list from which information (for example, SP discovery information) on a service discovery (SD) server may be obtained. First, addresses set in advance to the image display device or addresses manually set by a user may be used. Second, a dynamic host configuration protocol (DHCP)-based SP discovery method may be used. Third, domain name system (DNS) service location (SRV)-based SP discovery method may be used.

In addition, the image display device may connect to a server having an address obtained by any one of the above-described three methods, receive a service provider discovery record having information necessary for service discovery for each SP, and proceed to a service searching process by using the received service provider discovery record. The above-described processes may be enabled in a push mode or in a pull mode. The image display device may connect to an SP attachment server designated as an SP attachment locator in the SP discovery record, and perform a registration procedure (or a service attachment procedure).

The image display device may connect to an SP authentication service server designated as the SP authentication locator to perform a separate authentication procedure, and then perform a service authentication procedure.

After the successful service attachment procedure, data that are transmitted from the server to the image display device may be in a provisioning information table format.

In the service attachment procedure, the image display device may insert its own ID and location information into data to be transmitted to a service attachment server and provide the data. The service attachment server may specify a service to which the image display device subscribes on the basis of the received data.

Address information from which the image display device can obtain service information may be provided in a provisioning information table form. In addition, the address information may correspond to attachment information of the master SI table, and, in this case, it may be easy to provide a customized service for each subscriber.

The service information may include a master SI table record managing attachment information on and a version of a virtual channel map, a virtual channel map table providing a package type service list, a virtual channel description table including detailed information on each channel, and a source table including attachment information through which an actual service can be accessed.

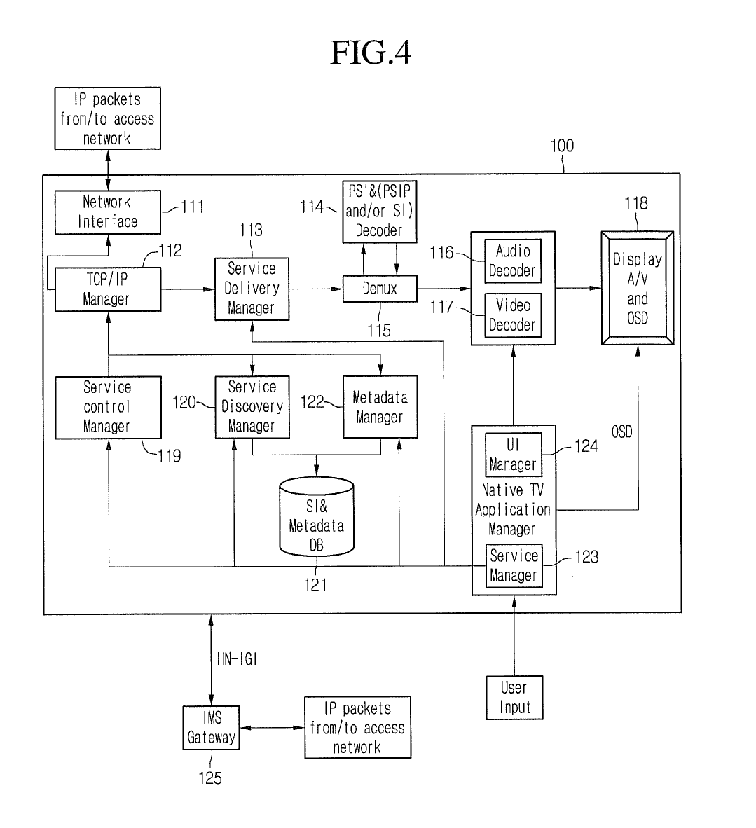

FIG. 4 illustrates a block diagram of a configuration of an image display device according to an embodiment.

Referring to FIG. 4, the image display device 100 may include a network interface 111, a TCP/IP manager 112, a service delivery manager 113, a demultiplexer 115, a program specific information (PSI) & (program and system information protocol (PSIP) and/or SI) decoder 114, an audio decoder 116, a video decoder 117, a display A/V and on screen display (OSD) module 118, a service control manager 120, a metadata manager 122m an SI&Metadata DB 121, a user interface (UI) manager 124, and a service manager 123.

The network interface 111 may receive packets from a network, and transmit packets to the network. Namely, the network interface 111 may receive services and contents from a service provider through the network.

The TCP/IP manager 112 may participate in transferring packets from a source to a destination, the packets being received by the image display device 100 and transmitted from the image display device 100. The TCP/IP manager 112 may classify received packets in order to correspond to proper protocols, and output the classified packets to the service delivery manager 115, the service discovery manager 120, the service control manager 119, and the metadata manager 122.

In addition, the service delivery manager 113 controls received service data, and for example, may use a real-time transport protocol (RTP)/real-time transport control protocol (RTCP) in case of controlling the real-time streaming.

When transmitting the real-time streaming data by using an RTP, the service delivery manager 113 may parse the received data packets according to the RTP to transmit it to the demultiplexer 115, or to store it to the SI&Metadata DB 121 according to a control of the service manager 123. In addition, the service delivery manager 113 may feed the network reception information back to a server, which provides the service, by using an RTCP.

The demultiplexer 115 demultiplexer the received packets into audio, video, and PSI data to transmit them respectively to the audio decoder 116, the video decoder 117, and the PSI&(PSIP and/or SI) decoder 114.

The PSI&(PSIP and/or SI) decoder 114 may decode service information, such as PSI, and may receive and decode, for example, a PSI section, a PSIP section or an SI section demultiplexed by the demultiplexer 115.

In addition, the PSI&(PSIP and/or SI) decoder 114 may decode the received sections to make a DB on the service information, and store the DB on the service information to the SI&Metadata DB 121.

The audio and video decoders 116 and 117 may decode audio data and video data received from the multiplexer 115, and the audio and video data may be provided to a user through the display A/V and OSD module 118.

The UI manager 124 and the service manager 123 may manage an overall state of the image display device 100, provide a UI, and manage other managers.

For example, the UI manager 124 may provide a graphic user interface (GUI) for a user by using an OSD, and receives key inputs from a user to perform a receiver operation according to the key inputs. In addition, the UI manager 124 may transmit key input signals to the service manager 123, when receiving key inputs about a channel selection from a user.

The service manager 123 may control managers related to the service delivery manager 113, the service discovery manager 120, the service control manager 119 and the metadata manager 122.

In addition, the service manager 123 may make a channel map, and select a channel by using the channel map according to key inputs received from the UI manager 124.

The service manager 123 may receive channel service information from the PSI&(PSIP and/or SI) decoder 114 to set audio/video packet identifiers (PIDs) for the selected channel to the demultiplexer 115.

The service discovery manager 120 may provide information necessary for selecting a service provider providing a service. For example, when the service discovery manager 120 receives a signal about channel selection from the service manager 123, it may search a service by using the received signal.

The service control manager 119 performs service selection and control by using, for example, an IGMP or a RTSP when a user selects the same live broadcasting service as an existing broadcast scheme or using an RTSP when a user selects a service, such as a video on demand (VOD).

The RTSP protocol may provide a trick mode for real-time streaming, and the service control manager 119 initializes and manages a session through an Instructional Media Center (IMC) gateway by using an IP multimedia subsystem (IMS) and a session initiation protocol (SIP).

The metadata manager 122 may manage metadata associated with a service and store the metadata in SI&Metadata DB 711.

The SI&Metadata DB 121 may store information necessary for selecting service information decoded by the PSI&(PSIP and/or SI) decoder 114, metadata managed by the metadata manager 120, and a service provider provided by the service discovery manager 120.

In addition, the SI&Metadata DB 121 may store setup data for a system, and may be implemented into, for example, a nonvolatile RAM (NVRAM) or a flash memory.

The IG 750 may be a gateway that functions necessary for accessing an IMS-based IPTV service are collected.

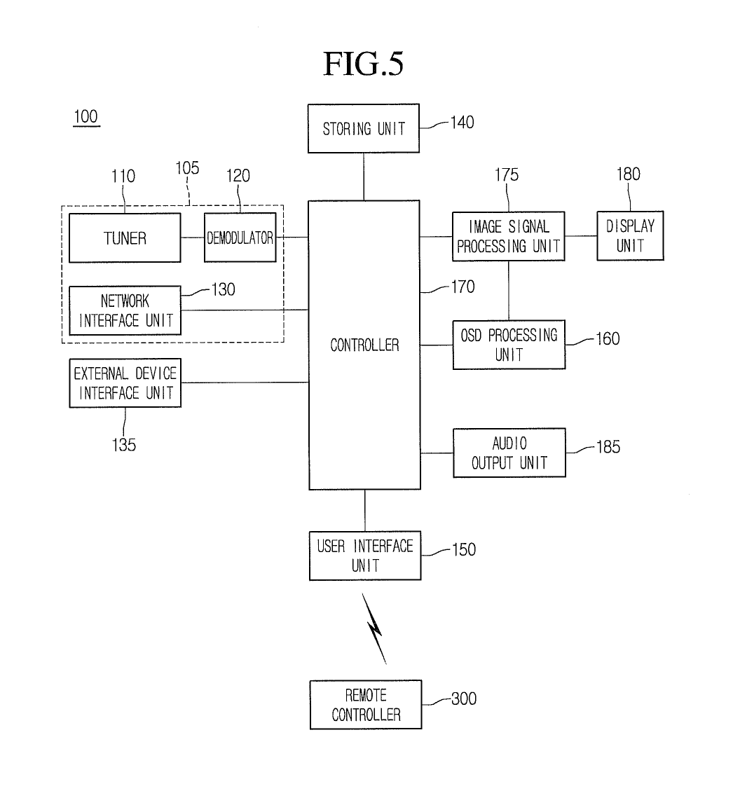

FIG. 5 is a block diagram illustrating a configuration of the image display device according to another embodiment.

Referring to FIG. 5, the image display device 100 according to the embodiment includes a communication unit 105 receiving contents or applications from a content providing server, a storing unit 140 storing the received applications or a list thereof, an image signal processing unit 175 outputting an image representing the received applications, a controller 170 obtaining at least one trial application from the application list stored in the storing unit 140 and extracting state information of the stored trial application, and a display unit 180 displaying the at least one trial application by adjusting at least one of transparency and supplementary display information for an image representing the at least one trial application on the basis of the extracted state information.

The communication unit 105 may receive applications or contents from an IPTV company, a content provider or an arbitrary service provider providing the VOD service. The received content may include movies, advertising, games, VOD, or broadcast signals and information related to the content. The application may include games, or software programs.

When content received through the communication unit 105 is a digital broadcast, the digital broadcast signal received through a tuner 110 may be transmitted in a packetized transport stream form in which audio and video signals and supplementary data are time-divisionally multiplexed.

In addition, content received through the communication unit 105 may be data packets received through the network interface unit 130.

The communication unit 105 may include a tuner 105 receiving a transport stream such as a broadcast signal transmitted externally from an IPTV company, a content service provider, and a cable network, a demodulator 120 outputting a broadcast signal of a specific tuned channel in a transport stream form via a vestigial sideband demodulating process and an error-correcting process, etc., and a network interface unit 130 receiving content through a network.

The broadcast signal received through the tuner 105 is demultiplexed by a demultiplexer (not shown) into a video signal, an audio signal and various supplementary data defined as PSIP information, and is output in a bit-stream form. The demultiplexer may be implemented as embedded in the controller 170.

The communication unit 1Q5 according to the present disclosure may receive state information on the trial application. When the state information is requested, a maker of the corresponding application may transmit the state information.

According to an embodiment as shown in FIG. 5, while a real-time broadcast is output to the display unit 180 through the tuner 110, the application list is simultaneously or independently displayed.

The video data demultiplexed by the demultiplexer is processed by the image signal processing unit 175 to be displayed on the display unit 180. At this time, the image signal processing unit 175 may include an MPEG-2 decoder and a scaler transforming the video data to be proper to a vertical frequency, resolution, and an aspect ratio meeting output specification of the display unit 180.

Here, as the display unit 180, various type of displays, such as digital light processing (DLP), a liquid crystal display (LCD), and plasma display panel (PDP), may be used.

The audio signal is processed by an audio signal processing unit (not shown) to be output to an audio output unit 185, and the audio signal processing unit may include an AC-3 decoder.

Furthermore, the supplementary data demultiplexed by the demultiplexer may be stored in the storing unit 140 to be described later.

The storing unit 140 may be implemented into an electrically erasable programmable read-only memory (EEPROM). The storing unit 140 according to an embodiment may store the applications or the trial applications received through the communication unit 105. Also, the storing unit 140 may store images representing the received applications or state information on the trial applications. The state information on the trial applications may include expiry information and use authority information. An image representing the trial application may include a thumbnail image or an icon.

The user interface unit 150, as a means for receiving request instructions from a user, may include an infrared signal receiving unit receiving an infrared signal, which is input through a remote controller, or a local key input unit embedded in one side of a panel. The user interface 150 may receive an infrared signal or a wireless communication signal from a remote controller 200.

In addition, the user interface unit 150 according to an embodiment may receive an application delete command. For example, when a user does not want to use the trial applications any more, or use authorities for the trial applications are expired, the user may input the application delete command through the user interface 150.

A network interface unit 130 receives contents or data from a content provider or a network operator through a network. Namely, the network interface unit 130 receives contents, such as a broadcast, a game, VOD, and a broadcast signal, and information related to the contents provided from the content provider through the network. In addition, the network interface unit 130 also receives update information and update files of firmware provided by the network operation through the network interface unit 130.

An OSD processing unit 160 may generate a menu screen for receiving a user's determination signal in an OSD form. Also, the OSD processing unit 130 may display contents and related information received through the network interface unit 130 on the display unit 130.

The OSD processing unit 160 according to an embodiment may generate an OSD screen in order to adjust transparency or supplementary display information for the image, which represents the trial application, on the basis of the state information of the trial application, and output as OSD layers.

An external device interface unit 135 may receive inputs from another player, for example, a DVD player, or a game player. The external device interface unit 135 may connect to another player to output multimedia stored in the other player on the display unit 180.

The controller 170 performs an overall operation control according to commands input from the user interface unit 150. The controller 170 receives and executes software from the content provider, namely, update files of firmware.

When the controller 170 according to an embodiment obtains the application list, which is stored in the image display device, and searches the application list stored in the image display device for at least one trial application.

In addition, the controller 170 may obtain the application list from the network or the storing unit 14, search the application list for at least one trial application, extract state information on the trial application, and determine state display information for displaying the trial application on the image display device on the basis of the state information. In addition, the controller 170 may control the display unit 180 to display states of applications in order for a user to easily know the states of the applications according to the state display information.

Furthermore, the image display device 100 according to the present disclosure may include a device, such as a set-top box, which is not equipped with a display. In this case, the controller 170 may output control signals for displaying the application list according to the present disclosure on an external display. The external display may generate and display an image corresponding to the application list according to the present disclosure by using the output control signal.

The controller 170 may control to play the content. At this time, the content may be the stored content in the image display device 100, the received broadcast content, or the externally input content input from the outside. The content may be at least one of broadcast images, externally input images, audio files, still images, a connected web page screen, and document files.

According to an embodiment, the image display device 100 according to the present disclosure may output 3-dimensional images. A menu screen of the image display device 100 may be provided 3-dimensionally. Even when content provided by the content provider is 3D content, the image display device 100 may receive and display the 3D content. For this, the image signal processing unit 175 may further include a 3D formatter (not shown) for outputting a 3D image.

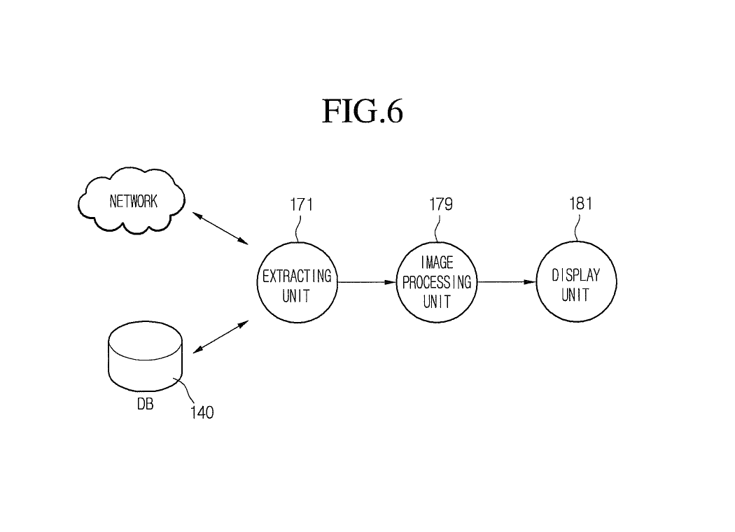

FIG. 6 is a simplified block diagram illustrating a data flow displaying state information according to an embodiment. Referring to FIG. 6, the image display device according to the present disclosure may include an extraction unit 171 as an element of the controller 170, an image signal processing unit 175, and a display unit 180.

The extraction unit 171 may obtain or receive an application list from a network or the DB 140. The extraction unit 171 may search and extract trial applications from among the obtained applications. The trial applications are a kind of application, and may include a demo version, a trial version, and a test version. Namely, as a temporarily available application, the trial application of the present disclosure may include all kinds of application whose period of use is limited or authority of use is restricted.

The extraction unit 171 may obtain state information of the trial application. The state information may include at least one of period of use, usable points, and the usable number of times.

The extraction unit 171 may determine display information that at least one of transparency and supplementary display information for an image, which represents corresponding application by using the state information, is adjusted, and transmit the display information to the image processing unit 179. The image processing unit 175 may process the image representing the application according to the display information. The image processing unit 175 may include an OSD graphic processer (not shown) to generate an OSD screen for the image representing the application.

The display unit 180 may display an image processed by the image processing unit 179.

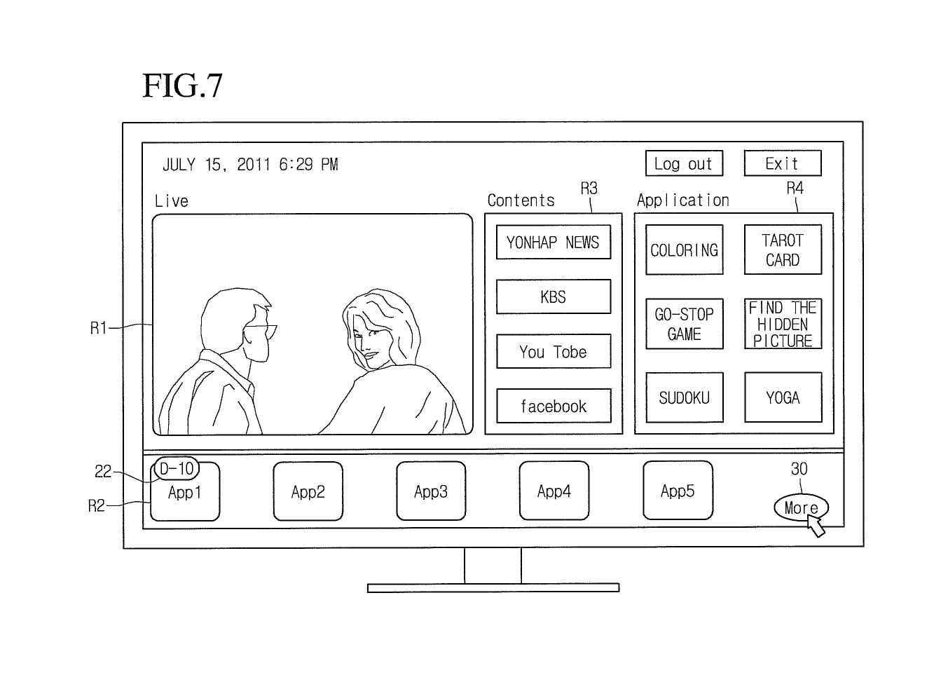

FIG. 7 illustrates an example that an application list is displayed on an image display device according to an embodiment. FIG. 7 illustrates an exemplified display screen after the image display device according to an embodiment is logged on through an account. Referring to FIG. 7, a first region R1 and a second region R2 are displayed. The first region R1 displays a real-time broadcast received through a turner. The second region R2 displays applications downloaded by a currently logged in user. Also, a third region R3 and a fourth region R4 can also be displayed together. The third region R3 displays a content provider list available to the currently logged in user, and the fourth region R4 displays App Stores from which applications can be bought or downloadable. Namely, the image display device according to an embodiment may display a list of applications downloaded by a user on the second region R2 together with the real-time broadcast, after the user logs in.

Referring to FIG. 7, state information “D-10” 22 may be displayed for Appl, which is different from other applications, from among applications displayed on the second region R2 where the application list is displayed. Namely, when the Appl is a trial application, state information of the application may be displayed as supplementary information so that a user can confirm period of use of the trial application, while watching a real-time broadcast. When “More . . . ” 30 is selected from the application list on the second region R2, the application list may be displayed in a full screen.

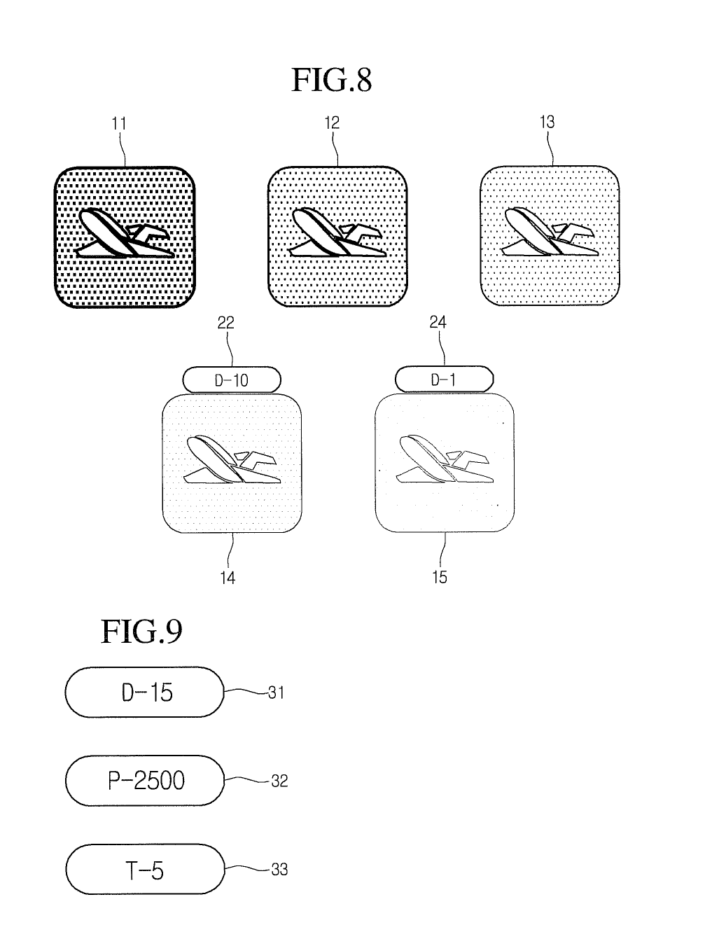

FIG. 8 illustrates an exemplary display of a state of an application according to an embodiment. Referring to FIG. 8, 5 images are displayed as examples of images representing applications. The images illustrated in FIG. 8 may be thumbnail images, or icons of the applications.

The image 11 may be a basic image displayed when corresponding application is not a trial version, but a normal application.

An image 12 and an image 13 show that transparencies thereof are adjusted according to a limited period of use of the application. For example, it is 10 days before the expiration date, the image 12 for representing this may have about 500 transparency compared to the basic image 11. Also, it is 5 days, less than 10 days, before the expiration date, the image 13 for representing this may have about 80% transparency compared to the basic image 11. From the transparency-processed images, a user can immediately know that the expiration date is approaching. Furthermore, when the state information is not available due to passing of the expiration date of the trial application, the images 11, 12, . . . may be processed to disappear. At the same time, data necessary for executing the trial application may be automatically deleted from the image display device.

An image 14 and an image 15 may further include supplementary display information 22 and 24 besides transparency processing to the basic image 11. The supplementary display information 22 and 24 may display the period of use as a number. A user can accurately recognize the state information of the trial application through the supplementary display information 22 and 24 beside the transparency-processed images.

FIG. 9 illustrates supplementary display information on state information on an application according to an embodiment. Even though FIG. 8 illustrates an exemplary period of use as the supplementary display information, FIG. 9 further illustrates point information, and the number of use times. Namely, supplementary display information 31 represents 15 days to the expiration date, supplementary display information 32 represents 2500 points to further use, and supplementary display information represents 5 times more to use for an application whose usable number of times is set. In FIG. 9, information displayed as the supplementary display information is exemplified as a period of use, the number of use times, and an available point, but the information is not limited thereto.

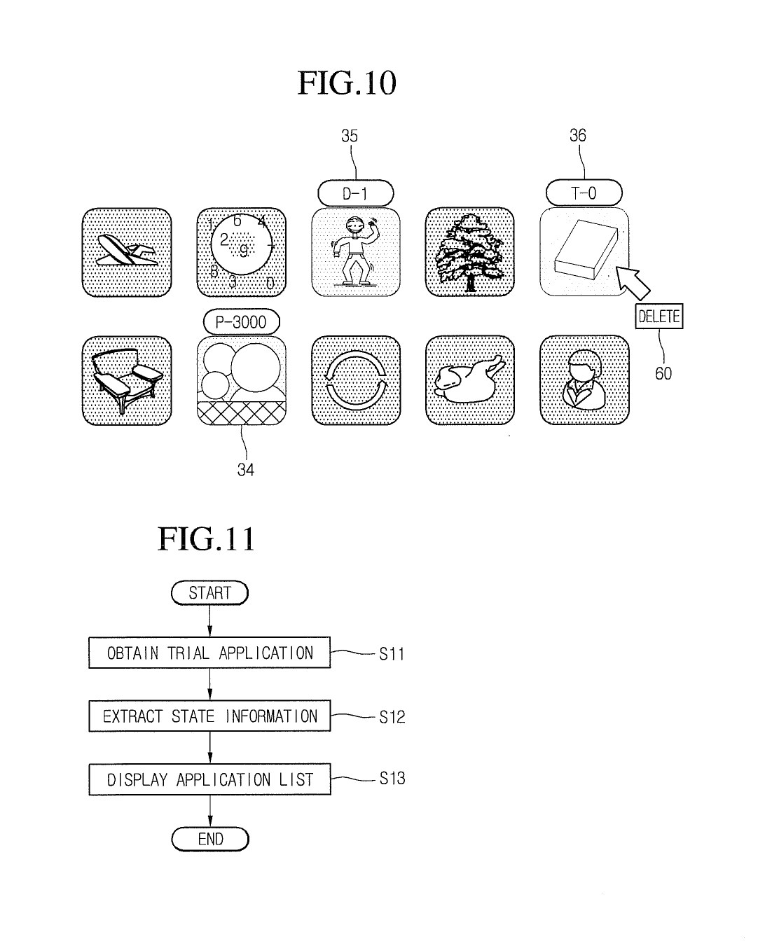

FIG. 10 illustrates exemplary arrangement of applications according to an embodiment. Referring to FIG. 10, state display information on 3 trial applications from among 10 applications is displayed. Namely, as the supplementary display information, a period of use 35 is displayed, and an image 34 including supplementary information having an available point indicated is also displayed. Also, an image 36 that represents a trial version having usable number of times 0 and being not able to use any longer is also exemplarily displayed. A user refers to state display information included in the trial application, select an application from the application list, and execute the application. In addition, the user may delete unavailable applications. When the user touches the unavailable applications with a pointer, a delete menu 60 may be displayed.

Even though an image of a trial application is arranged together with formal version in FIG. 10, they may be distinguishably displayed. Also, trial applications having expiration date approached or usable number of times smaller may be preferentially arranged. Namely, the image display device according to the present disclosure may rearrange an application list on the basis of state information.

FIG. 11 illustrates a flow chart of a content management method according to an embodiment.

In operation S11, the image display device obtains at least one trial application from an application list. For this, the application list stored in the image display device may be searched for the trial application.

In operation S12, state information of the trial application is extracted. The state information is obtained from a memory where the trial application is stored, or requested and received from an application distributor.

In operation S143, transparency or supplementary information for the application image is adjusted on the basis of the extracted state information and the trial application is displayed. In this case, an entire application list including the trial application may be displayed.

According to an image display device and a content management method using the same of the present disclosure, configurations and methods of the above described embodiments are not limitedly applied, but may be configured such that total or some of the embodiments described above are selectively combined to enable various modifications.

A content management method of an image display device according to the present disclosure can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices, and carrier waves such as data transmission through the Internet. The computer readable recording medium can also be distributed over network coupled computer systems so that the computer readable code is stored and executed in a distributed fashion.

Although embodiments have been shown and described, the present disclosure is not limited to the described embodiments. Instead, it should be understood that numerous other modifications and embodiments can be devised by those skilled in the art that will fall within the spirit and scope of the principles of this disclosure.

1. A content management method comprising:
obtaining at least one trial application from an application list stored in an image display device;
extracting state information of the stored trial application; and
adjusting at least one of transparency and supplementary display information for an image representing the at least one trial application on the basis of the extracted state information to display the at least one trial application.

2. The content management method of claim 1, wherein the obtaining of the at least one trial application comprises,
obtaining the application list stored in the image display device; and
searching the application list for the at least one trial application.

3. The content management method of claim 1, wherein the trial application has a limited period of use or restricted use authority.

4. The content management method of claim 1, wherein the state information comprises at least one of a period of use, a usable point, and the usable number of times of the trial application.

5. The content management method of claim 1, wherein the transparency and the supplementary display information is output as on-screen-demand (OSD) layers.

6. The content management method of claim 1, wherein the image comprises at least one of a thumbnail image, icon, and a logo of the trial application.

7. The content management method of claim 1, wherein the transparency is set to have predetermined levels according to the state information.

8. The content management method of claim 7, wherein, when the state information is not available, an image representing corresponding trial application is processed to disappear.

9. The management method of claim 1, further comprising rearranging applications in the application list on the basis of the state information.

10. An image display device managing content, comprising:
a controller obtaining at least one trial application from an application list stored in the image display device, and extracting state information of the stored trial application; and
a display unit adjusting at least one of transparency and supplementary display information for an image representing the at least one trial application on the basis of the extracted state information to display the at least one trial application.

11. The image display device of claim 10, wherein the controller obtains the application list stored in the image display device, searches the application list for the at least one trial application to obtain the at least one trial application.

12. The image display device of claim 11, wherein the trial application has a limited period of use or restricted use authority.

13. The image display device of claim 10, wherein the state information comprises at least one of a period of use, a usable point, and the usable number of times of the trial application.

14. The image display device of claim 10, wherein the transparency and the supplementary display information are output as OSD layers.

15. The image display device of claim 10, wherein the image comprises at least one of a thumbnail image, an icon and a logo.

16. The image display device of claim 10, wherein the controller sets the transparency to have predetermined levels according to the state information.

17. The image display device of claim 16, wherein, when the state information is not available, the controller processes the image representing the trial application to disappear.

18. The image display device of claim 10, wherein the controller rearranges applications in the application list on the basis of the state information.
